(19) United States
(12) Patent Application Publication
(10) Pub. No.: US 2019/0236943 A1
(43) Pub. Date: Aug. 1, 2019

(54) EMERGENCY TRAFFIC SIGNAL DEVICE

(71) Applicant: Brian H. West, Loxahatchee, FL (US)

(72) Inventor: Brian H. West, Loxahatchee, FL (US)

(21) Appl. No.: 16/239,180

(22) Filed: Jan. 3, 2019

Related U.S. Application Data
(60) Provisional application No. 62/616,915, filed on Jan. 12, 2018.

(51) Int. Cl. G08G 1/095; F21S 9/03; F21S 10/06; H05B 33/08

(52) U.S. Cl. CPC G08G 1/095; F21S 9/035; F21Y 2115/10; H05B 33/0848; F21S 10/06

(57) ABSTRACT

An emergency traffic signal device is provided including a bracket adapted to mount a battery, photovoltaic cell, and one or more LED lights to a traffic light. The battery, photovoltaic cell, and one or more LED lights may all be enclosed in a housing to protect the components for external elements. The emergency traffic signal device is wired such that a loss of power to the traffic light activates the LED lights, which flashes intermittently to alert drivers of their approach to an intersection. The LED lights are powered by the battery, which may be charged via the photovoltaic cell and also by power supplied to the traffic light.

### CLAIM OF PRIORITY

This application is being filed as a non-provisional patent application under 35 U.S.C. § 111(a) and 37 CFR § 1.53(b). This application claims priority under 35 U.S.C. § 119(e) to U.S. provisional patent application Ser. No. 62/616,915 filed on Jan. 12, 2018, the contents of which are incorporated herein by reference.

### TECHNICAL FIELD

This invention relates generally to emergency signal devices and in particular to a device that can be mounted on a traffic light and displays an emergency signal when power to the traffic light has been interrupted.

### BACKGROUND OF THE INVENTION

Traffic lights are a common feature on almost every road in the United States of America. They regulate the movement of automobiles at intersections and allow drivers to determine who has the right of way through visual cues, usually by the use of red, yellow, and green lights.

These traffic lights are regularly wired to a power grid that supplies the necessary electricity to power them. Often times, natural disasters or human error cause these power grids to lose power for brief or extended periods of time. In those instances, traffic lights become inoperable or defective due to the lack of electricity necessary to operate them. Because the lights are not properly working in these conditions, many drivers become unaware of who has the right of way in these situations. This forces drivers to operate motor vehicles in unsafe conditions where they are susceptible to accidents, sometimes fatal, that would otherwise be preventable.

In many such circumstances, this requires a police officer to direct traffic from the middle of the intersection. This not only places the officers at risk of being struck by inattentive drivers, but also takes them away from other important duties for which they might be of use. Additionally, many times a failure in the power grid causes outages of large areas that include several major intersections. Therefore, it may not be practical or even possible to have an officer directing traffic at each intersection.

Accordingly, there is a need in the art for an emergency traffic light device, which upon the outage of power to the primary traffic lights engages automatically and regulates the movement of automobiles at intersections without the need of human intervention.

### SUMMARY OF THE INVENTION

The following summary is provided to introduce a selection of concepts in a simplified form that are further described below in the detailed description. This summary is not intended to identify key features or essential features of the claimed subject matter, nor is it intended to be used to limit the scope of the claimed subject matter.

The present disclosure is directed to an emergency traffic signal device and system that is automatically activated upon power loss to the primary traffic system.

According to one implementation, the traffic signal device includes a bracket adapted to mount a photovoltaic cell, a battery, and one or more LED lights to a primary traffic light. Alternatively, the photovoltaic cell, the battery, and the one or more LED lights may be contained in a housing, whereby the components are protected from external elements, such as debris and severe weather. The device may also be configured to have the photovoltaic cell be integrated into the housing. In yet another implementation of the device, the emergency traffic signal device is integrated in the primary traffic light.

The photovoltaic cell has the capability to receive energy from sunlight, as well as other sources, and convert this energy into electric current. This electric current is then transmitted to the battery, which has the capability of storing electricity. The battery may also be charged with energy supplied from the electric current operating the primary traffic light under normal circumstances (i.e., electricity from the electric grid).

Upon the loss of power to the primary traffic light, the traffic signal device is activated and the electricity stored in the battery is utilized to power the one or more LED lights. When the battery supplies the electric current, the one or more LED lights illuminate intermittently to emit a flashing colored signal. Preferably, the color of the one or more LED lights is red; however, the color of the one or more LED lights may be any color or any combination of colors.

The one or more LED lights will emit the flashing colored signal to alert drivers that they are approaching the traffic light. Such a signal would indicate to drivers that the intersection should be treated as a “four way stop” due to an emergency. The one or more LED lights can be seen for more than a mile in clear weather, and more than a quarter mile in severe weather conditions. The one or more LED lights are viewable by the driver from any angle of approach to the intersection. The one or more LED lights may continue to flash for prolonged periods of time. Some LED lights may continue to work on battery power (which is recharged during daytime using the photovoltaic cell) for at least seven consecutive days.

When a normal electric current is restored to the traffic light (i.e., from the power grid), the one or more LED lights ceases to emit the flashing colored signal, and the battery will immediately return to its charging state, wherein the battery will store electric current from the photovoltaic cell and store electric current supplied to the traffic light from the grid. The battery may again be activated upon another instance of power loss.

These and other objects, features, and advantages of the present invention may be more clearly understood and appreciated from a review of ensuing detailed description of the preferred and alternate embodiments and by reference to the accompanying drawings and claims.

### BRIEF DESCRIPTION OF THE DRAWINGS

FIG. 1 is a perspective view of a first embodiment of the device according to the present invention in which the battery, photovoltaic cell and emergency LED are housed in a bracket that is separate from the traffic light.

FIG. 2 is a front view of the first embodiment of the device according to the present invention.

FIG. 3 is a perspective view of a second embodiment of the device according to the present invention in which the battery, photovoltaic cell and emergency LED are housed inside the traffic light.

FIG. 4 is a flow diagram of the operations of an embodiment of the device according to the present invention.

FIG. 5 is an electrical wiring diagram of the device according to an embodiment of the present invention.

### DETAILED DESCRIPTION OF THE INVENTION

While the present invention will be described more fully hereinafter with reference to the accompanying drawings, in which one or more embodiments of the present invention are shown, it is to be understood at the outset of the description which follows that persons of skill in the appropriate arts may modify the invention herein described while still achieving the favorable results of this invention. Accordingly, the description which follows is to be understood as being a broad, teaching disclosure directed to persons of skill in the appropriate arts, and not as limiting upon the present invention.

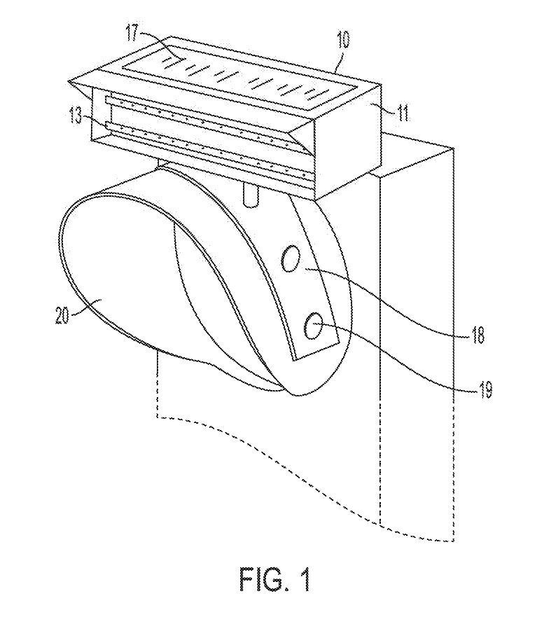

Referring initially to FIG. 1, an example implementation of an emergency traffic signal device 10 is disclosed. The emergency traffic signal device 10 comprises a photovoltaic cell 17, one or more LED lights 13, and a battery (not shown). The battery and the one or more LED lights 13 may be enclosed in a housing 11 to protect the components from external elements. The housing 11 may be constructed of a rigid, weather-proof or weather-resistant material such as metal, plastic, or the like. This embodiment of the invention is a “bolt-on” configuration suitable for retrofitting traditional traffic lights with an emergency LED signal, while retaining the original traffic light housing.

The photovoltaic cell 17 is capable of converting the energy of light into an electrical current. This electrical current is supplied to the battery and stored as electrical energy therein. The photovoltaic cell 17 may be an integrated component of the housing 11, situated on an upper face of the housing 11 so as to receive maximum sunlight. Alternatively, the photovoltaic cell 17 may be configured as a separate unit apart from the housing 11. In an embodiment of the device 10, the photovoltaic cell 17 may be located on an adjustable surface, whereby the angular position of the photovoltaic cell 17 relative the ground may be adjusted to an optimal position to receive maximum sunlight.

The emergency traffic signal device 10 may further consist of a bracket 18 for attachment to a primary traffic light 20. The bracket 18 may feature one or more bracket fasteners 19 to secure the bracket 18 to the primary traffic light 20. As shown in FIG. 1, the bracket 18 may be partially circular in shape as to mimic the contour of a typical primary traffic light 20 and enable proper attachment. However the bracket 18 may be designed in any shape known in the art so to best attach to the primary traffic light.

As further shown in FIG. 1, the one or more LED lights 13 may be fixed within the housing 11. The one or more LED lights 13 are connected to the battery, located within the housing 11. The housing 11 may comprise of a translucent panel such that the LED lights 13 may be visible from outside the housing. The panel shall be positioned on the same side in which the primary traffic light 20 faces, whereas any light produced by the one or more LED lights 13 would be visible from a vantage point in which drivers see light from an operating primary traffic light 20. Alternatively, the LED lights 13 may be affixed to the exterior of the housing, whereby no translucent panel is required. Upon a loss of power to the primary traffic light 20, electronic circuitry, which is known to those in the art, automatically senses the power loss and activates the LED lights using the battery. The battery powers the one or more LED lights 13, which flash intermittently, so that drivers understand they are approaching an intersection. It is preferable that the LED lights 13 emit red light, but the LED lights 13 may be of any color or color combination used in the art.

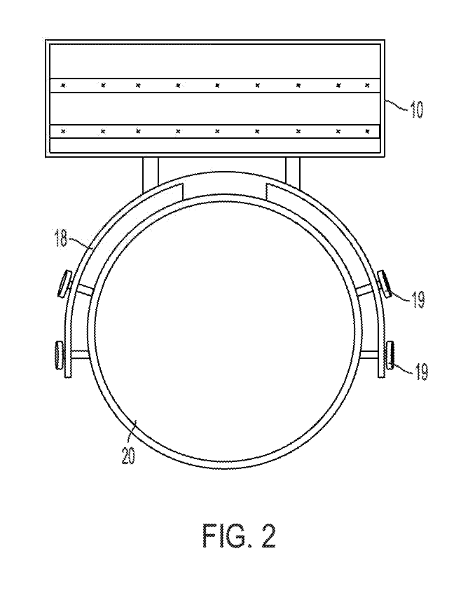

Referring to FIG. 2, the emergency traffic signal device 10 is situated directly above the primary traffic light 20. The bracket 18 may encompass the primary traffic light 20 and partially rest on an upper area of the primary traffic light 20. The bracket fasteners 19 may be situated on opposite, peripheral sides of the bracket 18 on opposite sides of the primary traffic light 20. The bracket fasteners 19 may be designed as threaded rods, whereby they are fastened through a threaded hole in the bracket 18. As each bracket fastener 19 is tightened, a distal end of the bracket fastener 19 approaches the primary traffic light 20, until contact is made with an outer rim of the primary traffic light 20. As the bracket fasteners 19 are further tightened, the pressure of the distal ends of the bracket fasteners 19 upon the primary traffic light 20 is increased, and these opposing pressures on opposite sides of the primary traffic light 20 secure the bracket 18 in place. Alternatively, the bracket 18 of the emergency traffic signal device 10 may be attached to the primary traffic light 20 in any other method of attachment known in the art, such as nut-and-bolt fasteners, adhesives, straps, screws, or the like.

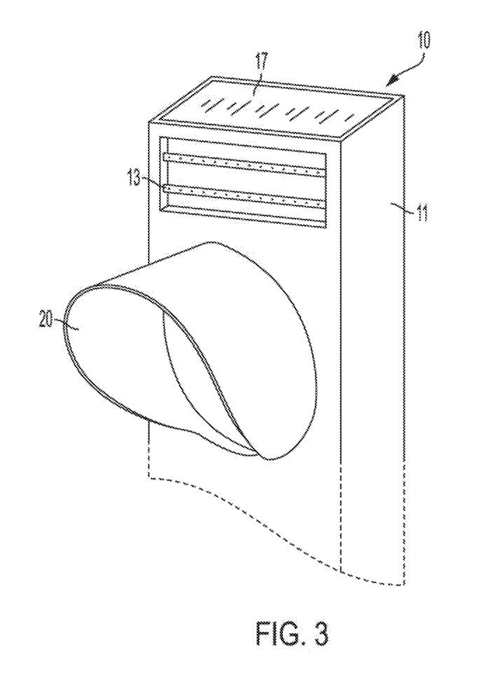

As detailed in FIG. 3, the emergency traffic signal device 10 may be integrated into a single unit with the primary traffic light 20. In this embodiment, the one or more LED lights 13 are similarly located above the primary traffic light 20. The housing 11 incorporates the one or more LED lights 13, the battery, and also any components of the primary traffic light 20. The photovoltaic cell may also be integrated within the housing 11 and located on an upper surface of the housing 11 to best capture sunlight. The incorporation of the emergency traffic signal device 10 and the primary traffic light 20 allow for a design that is less bulky and does not require additional installation of the bracket component.

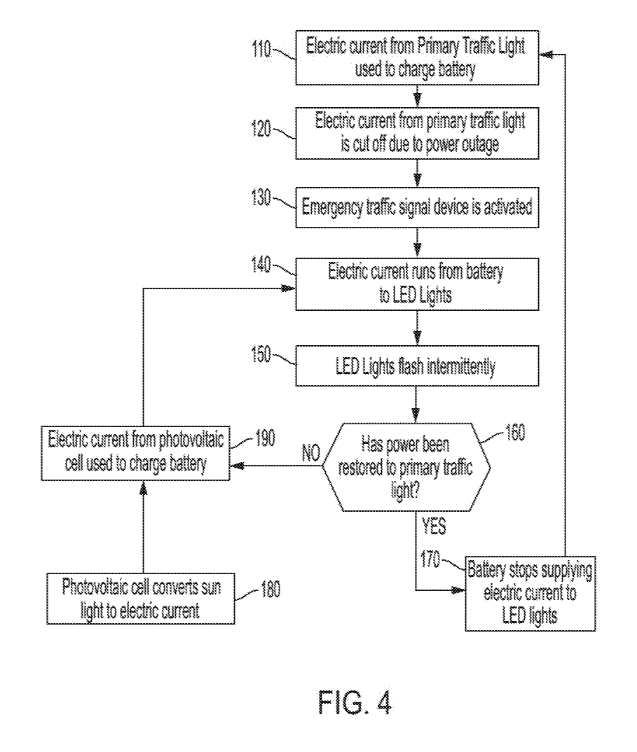

Referring to FIG. 4, a flow diagram of an embodiment of the emergency traffic signal device 10 is shown. The device 10 is wired so that it may receive an electric current that is supplied to the primary traffic light 20. In step 110, the electric current from the primary traffic light may be used to charge the battery. In the event that the electric current from the primary traffic light 20 is cut off (step 120), the emergency traffic signal device 10 is activated (step 130). The stoppage of electric current supplied from the primary traffic light 20 triggers a switch, whereby current stored in the battery is used to power the LED lights 13 (step 140). The LED lights 13 are wired such that they optionally flash at intermittent intervals (step 150). The device monitors whether power has been restored to the primary traffic light (step 160). If the emergency traffic signal device detects that current is restored to the primary traffic light 20, the battery stops supplying power to the LED lights 13 (step 170). If electric current is not being supplied to the primary traffic light 20, the electric current from the battery is used to continually supply energy to the to the LED lights 13. The photovoltaic cell 17 converts light to electric current (180) which is then used to charge continually charge the battery (190) in the absence of the power supplied from the primary traffic light. The battery will supply power to the LED lights 13 until power to the primary traffic light 20 is restored, or until the battery is depleted and no longer capable of supplying the energy requirements of the LED lights, which may be seven days or longer.

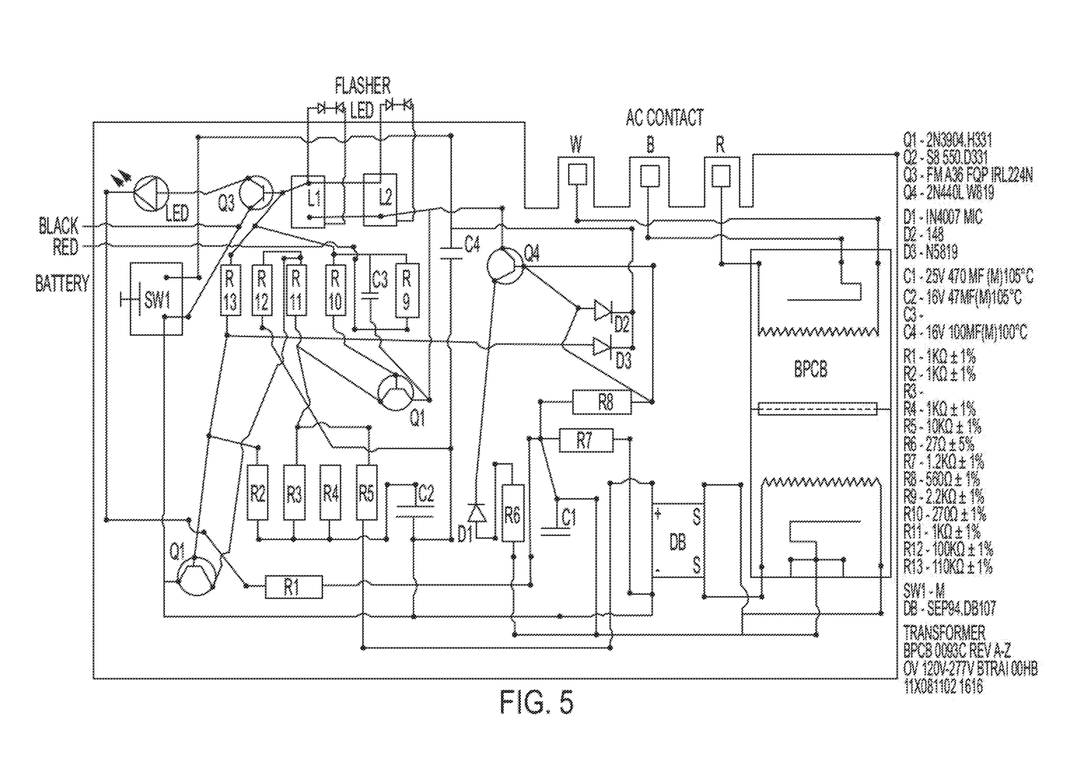

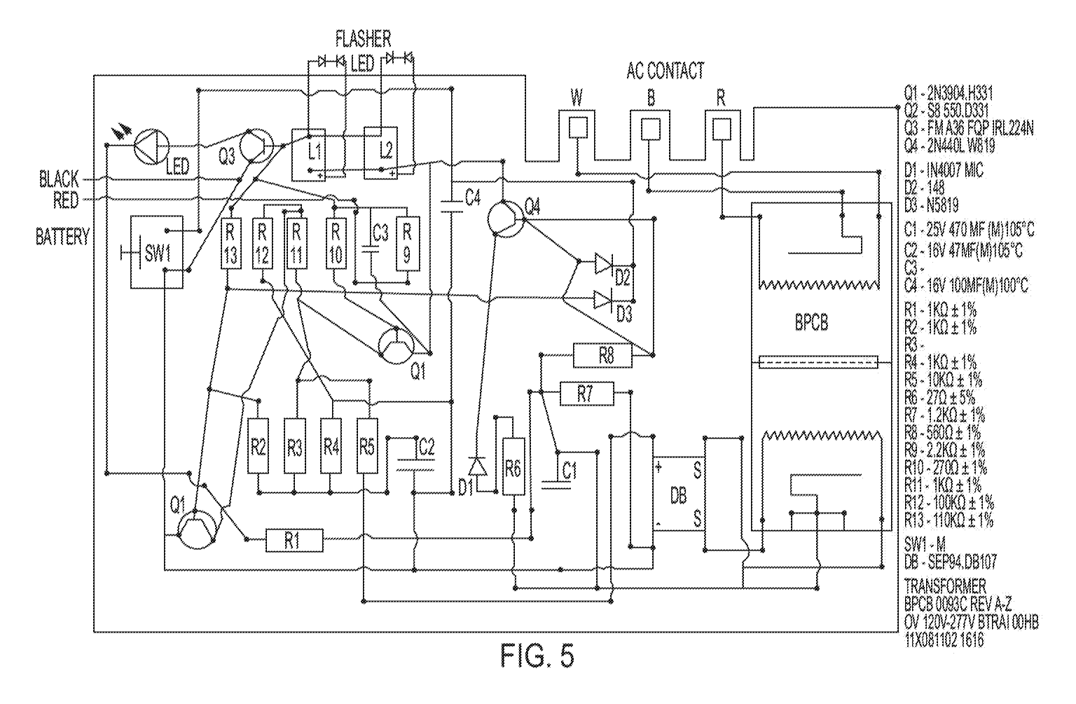

Referring to FIG. 5, a circuit diagram for an embodiment of the emergency traffic signal device 10 is disclosed. As shown, the device 10 has the ability to receive current from an alternating current source, such as the primary traffic light 20, and to store the current in a battery. The device 10 also has the capability to detect when current from the alternating current source has ceased, the detection of which triggers the activation of the one or more LED lights 13 with power being supplied by the battery. Once current from the alternating current source is resupplied to the device, the LED lights are deactivated and the current from the alternating current source is used once again to charge the battery.

Accordingly, it will be understood that the various embodiments of the present invention has been disclosed by way of example and that other modifications and alterations may occur to those skilled in the art without departing from the scope and spirit of the appended claims.

What is claimed is:

1. A traffic signal device comprising:
a bracket adapted to mount a photovoltaic cell, a battery, and one or more LED lights to a traffic light, the traffic light connected to an electric grid;
the battery adapted to store electric current from the photovoltaic cell and to store electric current supplied to the traffic light by the electric grid;
the one or more LED lights adapted to receive an electric current from the battery and to intermittently flash when the traffic light is not supplied an electric current by the electric grid;
the one or more LED lights adapted to cease flashing when the traffic light is supplied an electric current by the electric grid.

2. The traffic signal device of claim 1, wherein the photovoltaic cell may be positioned at various angles relative to the bracket to maximize sunlight received.

3. The traffic signal device of claim 1, wherein the battery and the one or more LED lights enclosed within a housing.

4. The traffic signal device of claim 3, wherein the photovoltaic cell is integrated in an upper surface of the housing.

5. A traffic signal device comprising:
one or more traffic lights;
a photovoltaic cell attached to the traffic light;
a battery attached to the traffic light and adapted to store electric current from the photovoltaic cell and to store electric current supplied by an electric grid;
one or more LED lights attached to the traffic light and configured to receive an electric current from the battery and to intermittently flash when the traffic light is not supplied an electric current by the electric grid;
the one or more LED lights adapted to cease flashing when the traffic light is supplied an electric current by the electric grid.
